(19) United States
(12) Patent Application Publication
(10) Pub. No.: US 2006/0280242 A1
(43) Pub. Date: Dec. 14, 2006

(54) System and method for providing one-pass rate control for encoders

(75) Inventor: Kemal Ugur, Tampere (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/151,628

(22) Filed: Jun. 13, 2005

(51) Int. Cl. H04N 11/04; H04B 1/66; H04N 7/12; H04N 11/02

(52) U.S. Cl. 375/240.03; 375/240.24; 375/240.12

(57) ABSTRACT

A one-pass rate controller for compressed video encoders that can be configured to comply with buffering schemes specified in video-coding standards. A plurality of RD-models with different window sizes are used to estimate the quantization parameters for constant quality and constant rate scenarios for that particular window. A buffer regulator implements an upper and lower limit on the number of bits that can be used for a specific frame. A modulator chooses the best quantization parameters based upon the information provided by the buffer conditions and the status of the rate distortion models. An in-frame quantization parameter adjuster decides if the quantization parameter needs to be adjusted while encoding the frame, as well as adjusting the quantization parameter if necessary.

### FIELD OF THE INVENTION

The present invention relates generally to rate controllers for compressed video encoders. More particularly, the present invention relates to one-pass rate controllers for compressed video encoders that can be configured to comply with buffering schemes specified in video-coding standards.

### BACKGROUND OF THE INVENTION

Most practical video transmission technologies currently require the coded video stream to adhere to restrictions in terms of average bit rate and bit rate variations. Bit rate variations are commonly expressed in terms of buffering requirements. All current video compression standards either normally or informatively contain a buffering model which an encoder's rate control scheme needs to fulfill in order to form a compliant bit stream.

The 3rd Generation Partnership Project (3GPP) is a collaboration created with the purpose of creating a globally applicable mobile telephone system specification within the scope of International Mobile Telecommunications-2000 (IMT-2000) mobile systems. 3GPP is considering requiring a minimum quality level for all production encoders. Rate control schemes for 3GPP terminal-based encoders need to be reasonably lightweight in terms of cycles and memory consumption. Such schemes also need to be flexible in terms of buffering requirements so as to be able to cope with the constraints of the different applications (e.g., recording applications, streaming service applications, conversational applications, etc.) of a 3GPP terminal-based encoder. Furthermore, such schemes also must be of a high quality in order to improve the user experience. Lastly, these schemes need to fulfill the buffering requirements set by the standards at all times in order to ensure compliant bit streams and interoperability.

Although there are no fewer than thirty known different rate control schemes, none of these schemes meet all of the above-identified requirements, namely being light-weight, single-pass, flexible in terms of applications, and strict enough to guaranty compliance with the buffering schemes of the video coding standards relevant to 3GPP (e.g., H.263 baseline, MPEG-4 part 2 simple profile, and AVC baseline standards.)

### SUMMARY OF THE INVENTION

The present invention addresses the above-identified issues by providing a one-pass rate controller for compressed video encoders. The controller of the present invention can be configured to comply with the buffering schemes specified in current video-coding standards. The present invention includes a plurality of rate distortion (RD) models with different window sizes for estimating the quantization parameters (QP) for constant quality and constant rate scenarios for each window. A buffer regulator is used to implement an upper and lower limit on the number of bits that can be used for a specific frame. A modulator chooses the best QP based upon the information provided by the buffer conditions and the status of the RD models, and an in-frame QP adjuster decides if the QP needs to be adjusted while encoding the frame. The in-frame QP adjuster adjusts the QP if necessary.

The present invention fully utilizes the decoder buffer and provides an improved user experience, with minimal buffer overflows and underflows with low quality variations. When utilizing two RD models with different window sizes, a better balance between constant quality and constant rate operation can be achieved. At the same buffer sizes, the developed rate controller can achieve improved subjective quality by less quality variance. Also, the objective quality measure is improved when compared to earlier solutions.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an overview diagram of a system within which the present invention may be implemented;

FIG. 2 is a perspective view of a mobile telephone that can be used in the implementation of the present invention;

FIG. 3 is a schematic representation of the telephone circuitry of the mobile telephone of FIG. 2;

FIG. 4 is a flow chart showing the steps involved in the rate control system of the present invention; and

FIG. 5 is a flow chart showing the steps involved in implementing an algorithm to find an initial QP for the frame in the present invention.

### DETAILED DESCRIPTION OF THE PREFERRED EMBODIMENTS

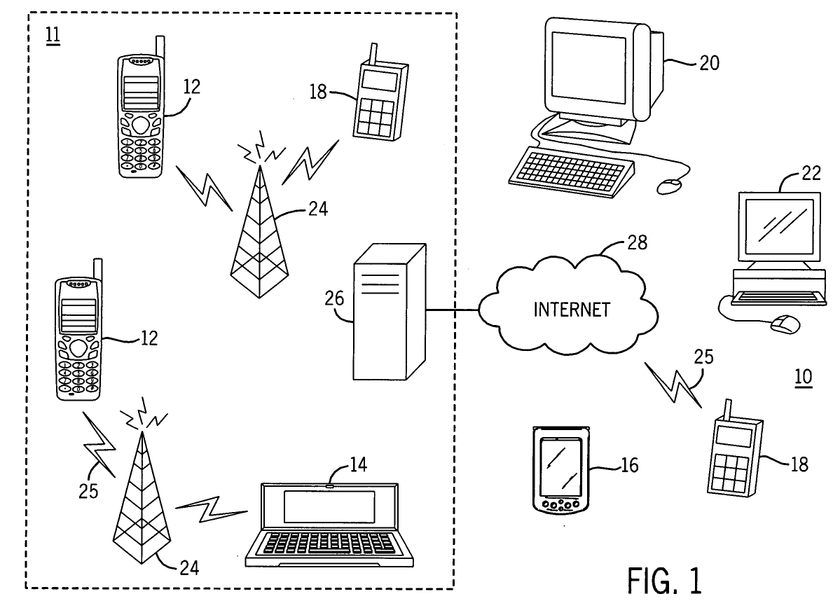

FIG. 1 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMID) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

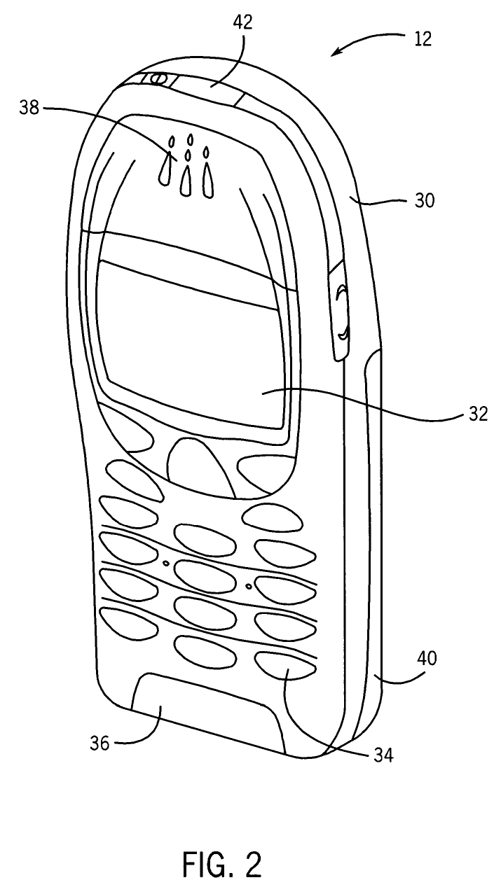

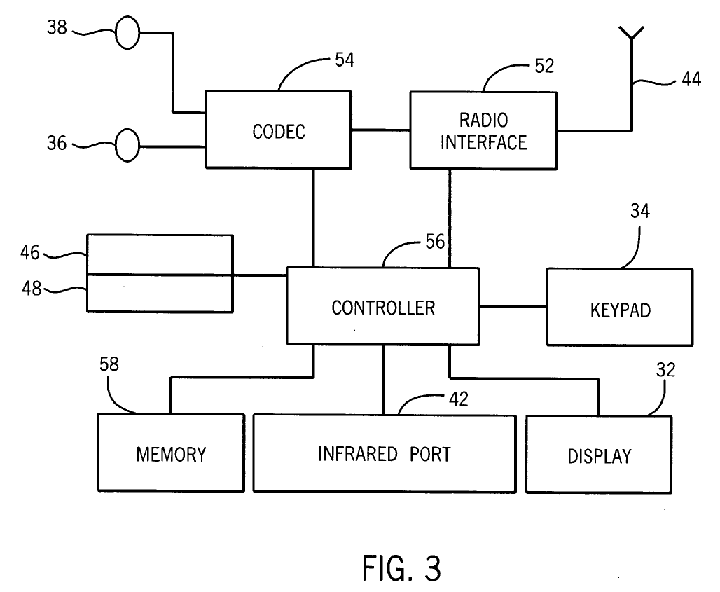

FIGS. 2 and 3 show one representative mobile telephone 12 within which the present invention may be implemented. It should be understood, however, that the present invention is not intended to be limited to one particular type of mobile telephone 12 or other electronic device. The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention provides for a one-pass rate controller for compressed video encoders. The controller can be configured to comply with the buffering schemes specified in current video-coding standards. The present invention includes a plurality of rate distortion (RD) models with different window sizes for estimating the quantization parameters (QP) for constant quality and constant rate scenarios for each window. A buffer regulator is used to implement an upper and lower limit on the number of bits that can be used for a specific frame. A modulator chooses the best QP based upon the information provided by the buffer conditions and the status of the RD models, and an in-frame QP adjuster decides if the QP needs to be adjusted while encoding the frame. The in-frame QP adjuster adjusts the QP if necessary.

Most rate controller algorithms make use of a rate distortion model, which relates the number of bits used by the frame to either the frame's complexity, the QP used to encode the frame, or both features. One RD model that can be used with the present invention is the model proposed by Lee, Chiang and Zhang entitled “Scalable Rate Control for MPEG-4 Video”, in IEEE Circuits and Systems for Video Technology journal. Other RD models that relate the quantization parameter to the number of bits used for the frame could also be used.

$$\frac{{R}_{tex}}{MAD} = \frac{{a}_{1}}{{QP}^{2}} + \frac{{a}_{2}}{QP} \qquad Eq . ( 1 )$$

In Equation 1, Rₜₑₓ refers to the number of bits used to code texture information (the residual) of the frame, MAD is the mean absolute distortion of the motion-compensated prediction error of the frame, QP is the quantization parameter used for the frame, and a₁ and a₂ are the model parameters. This model defines Rₜₑₓ as a quadratic function of the frame's distortion and the quantization parameter. The characteristics of the quadratic are defined by the model parameters a₁ and a₂. After encoding each frame, the rate controller (RC) uses the previous frame's Rₜₑₓ, MAD and QP information and updates the model parameters a₁ and a₂ using the least squares estimation technique. The number of frames that are used to update the RD model can vary and it is referred to herein as the window size of the RD model.

The window size plays an important role on the characteristics of the RD model, and therefore affects how the rate controller operates. Short window (SW) models are capable of capturing the characteristics of the video very quickly and are appropriate for constant bit rate applications with a low decoder buffer. The characteristics of long window (LW) models are slow changing, resulting in a near-constant quality video, and are therefore appropriate for cases where large decoder buffers are available.

The present invention involves an RC algorithm that is based upon using two RD models with different window sizes. The present invention also involves the use of a novel way to calculate the QP for the frame using buffer fullness, and the SW and LW models. In addition, a PI-based controller is used to decrease the number of buffer overflows and underflows.

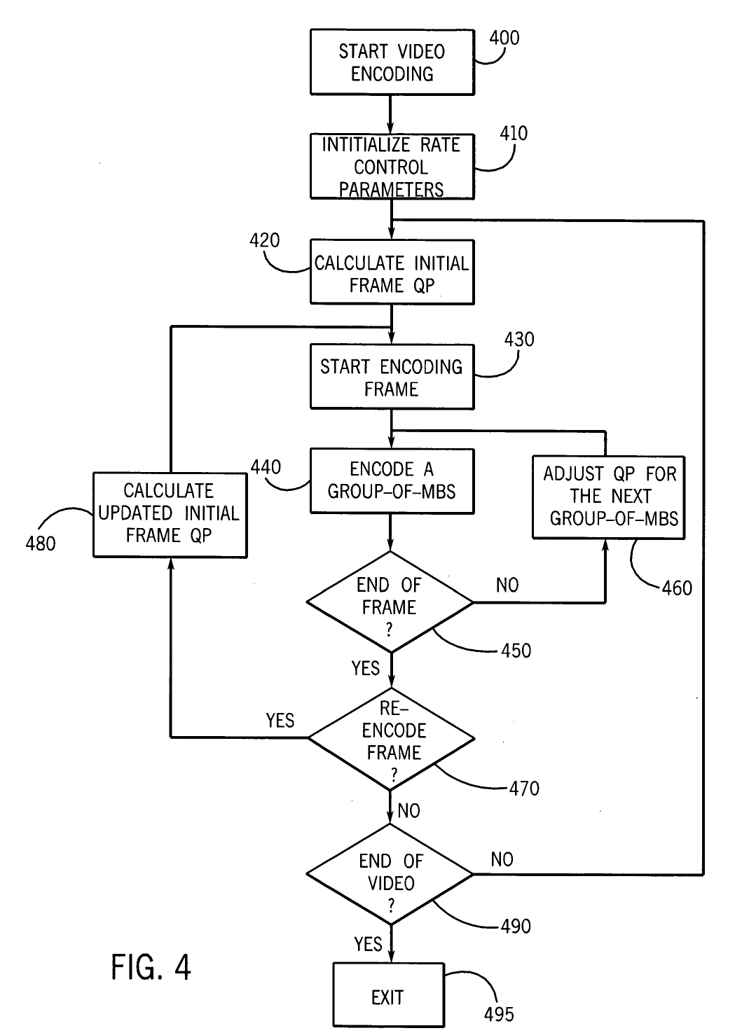

FIG. 4 is flow chart depicting the steps involved in the implementation of the algorithm of the present invention. At step 400, video encoding starts. At step 410, RC related parameters such as bit rate, buffer size, etc. are initialized. Prior to encoding each frame, the RC calculates the initial QP for the frame at step 420 and allocates the maximum and minimum number of bits that the frame is allowed to use. The maximum and minimum number of bits is referred to as the frame's bit-envelope. The encoding of the frame is initiated at step 430. A group of macroblocks (MBs) are encoded at step 440. At step 450, the RC determines whether the number of bits that have been generated so far are within the boundaries set by frames' bit-envelope and, if not, the QP is adjusted accordingly for the next group of MBs at step 460. When the encoding of the frame is complete, it is determined whether the frame needs to be re-encoded at step 470. If the frame needs to be re-encoded, the RC parameters and the RD models are updated at step 480, according to the results of the frame encoding. This process is repeated until no reencoding is necessary. It is then determined at step 490 whether the end of the video has been reached. If the end of the video has not been reached, then the process is repeated for the next frame. If the end of the video has been reached, then the process is completed at step 495.

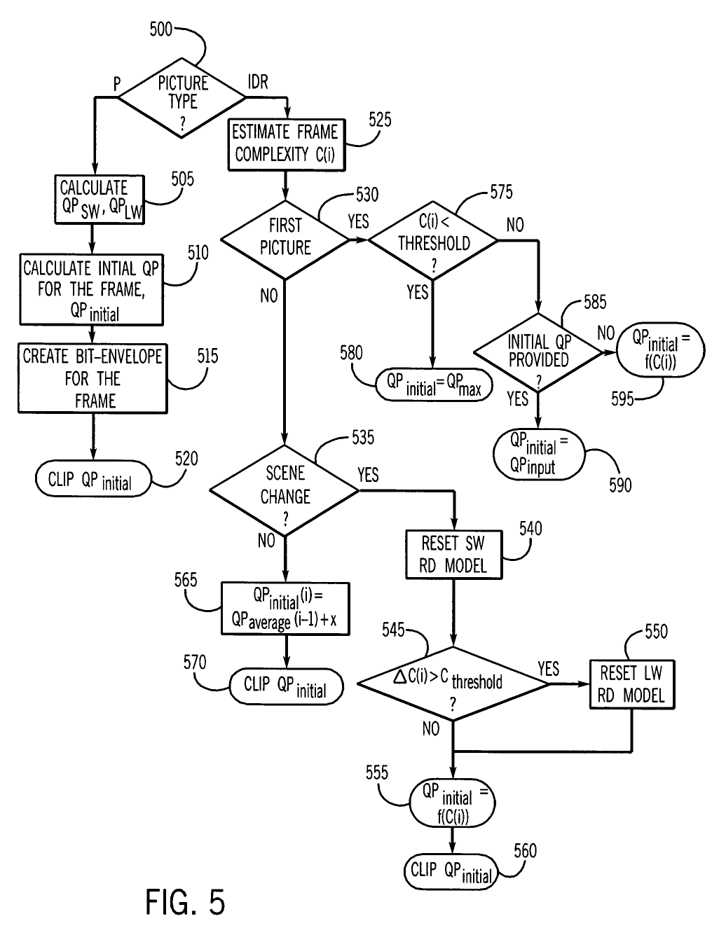

FIG. 5 is a flow chart presenting the algorithm that is used to calculate the QP for the frame in one embodiment of the present invention. The first frame QP is either accepted as an input parameter or is calculated. The QP for ideal data representation (IDR) frames is calculated in a different manner than those for P frames, which contain only predictive information (not a whole picture) generated by looking at the difference between the present frame and the previous frame, so the picture type is first determined at step 500. The algorithm depicted in FIG. 5 does not rely upon RD models when the number of frames within the RD model window is below a certain threshold, such as below 3, and uses the previous frame's average QP (i.e., the average of QPs used in all macroblocks for the previous frame).

First, the target number of bits for the frame is calculated using the following equation:

$${R}_{target} ( i ) = \{ \begin{matrix}\frac{{R}_{video}}{f} - \frac{{Δ}_{error}}{W} , number of frames to code is not known \\ \frac{{R}_{video}}{f} - \frac{{Δ}_{error}}{min ( W , num\_frames - i )} , \begin{matrix}number of frames \\ to code is known\end{matrix}\end{matrix} \qquad Eq . ( 2 )$$

R_{target}(i) is the target number of bits for the i^{th} frame; R_{video} is the video bit rate; f is the frame rate for the video and Δₑᵣᵣₒᵣ is the difference between the number of bits used until coding the i^{th} frame and the number of bits that would be used if all the prior frames were coded at an ideal rate of R_{video}f. W is the bit adjust window length and num_frames is the total number of frames of the video.

After the target number of bits for the frame is calculated, two QP's, QP_{SW} and QP_{LW}, are found at step 505 using the following quadratics for a P picture type:

$$\begin{matrix}\frac{{R}_{target} ( i ) * \frac{{R}_{tex} ( i - 1 )}{{R}_{tex} ( i - 1 ) + {R}_{header} ( i - 1 )}}{{MAD}_{avg} ( SW\_size )} = \frac{{a}_{1 , SW}}{{QP}_{SW}^{2}} + \frac{{a}_{2 , SW}}{{QP}_{SW}} & Eq . ( 3 ) \\ \frac{{R}_{target} ( i ) - {R}_{header , avg} ( LW\_size )}{{MAD}_{avg} ( LW\_size )} = \frac{{a}_{1 , LW}}{{QP}_{LW}^{2}} + \frac{{a}_{2 , LW}}{{QP}_{LW}} & Eq . ( 4 )\end{matrix}$$

Rₜₑₓ(i-1) is the number of texture bits used for coding the previous frame. R_{header}(i-1) is the number of header bits used for coding the previous frame. SW_size is the short window RD model's window size. LW_size is the long window RD model's window size. MAD_{avg}(x) is the average of the previous frame's MAD calculated over a window size, x. (a_{1,SW}, a_{2,SW}) and (a_{1,LW}, a_{2,LW}) are the RD Model parameters for the short and long window, respectively.

The change in QP_{SW} and QP_{LW} is limited to 2. QP_{LW} is calculated once every five frames, while QP_{SW} is updated at every frame.

the buffer fullness ratio, γ, is defined as

$$γ = \frac{{B}_{fullness} ( i )}{{B}_{size}} .$$

B_{fullness}(i) is the buffer occupancy at the time of coding frame (i), and B_{size} is the size of the buffer.

Using γ, QP_{SW} and QP_{LW}, the initial QP for the frame, is calculated at step 510 using the following piecewise-linear function:

$${QP}_{initial} ( i ) = \{ \begin{matrix}{QP}_{average} ( i - 1 ) - 2 ; & γ < 0.05 \\ {QP}_{weighted} ( i ) ; & 0.05 \leq γ < 0.35 \\ {QP}_{LW} ; & 0.35 \leq γ < 0.65 \\ {QP}_{weighted} ( i ) ; & 0.65 \leq γ < 0.95 \\ {QP}_{average} ( i - 1 ) + 2 ; & 0.95 \leq γ\end{matrix} \qquad Eq . ( 5 )$$

Equation 6 below defines three zones of operation according to the buffer fullness. These zones comprise very critical zones, where γ<0.05 and 0.95≦γ; less critical zones where 0.05≦γ<0.35 and 0.65≦γ<0.95, and an uncritical zone where 0.35≦γ<0.65. For the uncritical zone, the initial QP for the frame is the same as the QP_{LW} that favors a constant quality video when the buffer fullness is at the desired level. For the very critical zone, the initial QP for the frame is disruptly changed from the previous frame's average QP according to the buffer fullness in order to avoid buffer overflow and underflows. For the rest of the zones, the QP is calculated using the following equation:

$${QP}_{weighted} ( i ) = \{ \begin{matrix}MAX ( \begin{matrix}\vert γ - 0.5 \vert \cdot 2 \cdot {QP}_{SW} + \\ ( 1 - \vert γ - 0.5 \vert \cdot 2 ) \cdot {QP}_{LW} , {QP}_{LW}\end{matrix} ) , & γ \geq 0.65 \\ MIN ( \begin{matrix}\vert γ - 0.5 \vert \cdot 2 \cdot {QP}_{SW} + \\ ( 1 - \vert γ - 0.5 \vert \cdot 2 ) \cdot {QP}_{LW} , {QP}_{LW}\end{matrix} ) , & γ \leq 0.35\end{matrix} \qquad Eq . ( 6 )$$

The QP_{weighted} is the weighted average of QP_{SW} and QP_{LW}. The corresponding weights of QP_{SW} and QP_{LW} depend upon the buffer fullness. If the buffer is close to overflow or underflow, QP_{SW} will have a larger weight favoring constant bit rate video, whereas QP_{LW} will have a larger weight when the buffer fullness is not critical favoring constant quality video.

Following this computation, the frame's bit-envelope is calculated at step 515 using a PI-based controller. In one embodiment of the invention, the frame's bit-envelope is calculated with a similar method as proposed by Sun and Ahmad in the academic paper entitled “A Robust and Adaptive Rate Control Algorithm for Object-Based Video Coding” published in IEEE Circuits and Systems for Video Technology journal. It is to be understood that the control mechanism may be implemented with various mechanisms known from the art. These other mechanism can comprise, for example, P-, PD-, PID-controllers, or nonlinear control mechanism such as, for example, fuzzy-, neural-, H_{∞}- and/or PQ-controllers. The bit-envelope comprises the upper and lower limits on the number of bits that the frame can use, with the goal of minimizing the possibility of buffer overflows and underflows. The upper limit Rᵤₚₚₑᵣ(i) is first initialized to be twice of the target number of bits for the frame. The lower limit R_{lower}(i) is adjusted to be one-fourth of the target number of bits for the frame.

$${R}_{upper} ( i ) = {R}_{target} ( i ) \cdot 2$$

$${R}_{lower} ( i ) = \frac{{R}_{target} ( i )}{4}$$

The error signal E is then used to measure the difference between the target buffer fullness and the actual buffer fullness at the time of coding frame (i). This is defined as

$$E ( i ) = \frac{\frac{{B}_{size}}{2} - {B}_{fullness} ( i )}{\frac{{B}_{size}}{2}} .$$

This error signal is then sent to the PI controller.
PI(i)=Kₚ.(E(i)+Kᵢ.∫E(i).di)

Kₚ and Kᵢ are the proportional and integral control parameters, respectively. According to the sign of PI(i), the upper and lower limits are further adjusted by
if (PI(i)≦0) [symbol] Rᵤₚₚₑᵣ(i)=Rᵤₚₚₑᵣ(i).(1+max(−0.5,PI(i)))
if (PI(i)>0) [symbol] R_{lower}(i)=R_{lower}(i).(1+min(0.5,PI(i.)))

The minimum and maximum quantizer values (QPₘᵢₙ and QPₘₐₓ) for the frame are calculated according to Rᵤₚₚₑᵣ(i) and R_{lower}(i) using the following formulas:

$$\frac{{R}_{upper} ( i ) - {R}_{header , avg} ( SW\_size )}{{MAD}_{avg} ( SW\_size )} = \frac{{a}_{1 , SW}}{{QP}_{min}^{2}} + \frac{{a}_{2 , SW}}{{QP}_{min}}$$

$$\frac{{R}_{lower} ( i ) - {R}_{header , avg} ( SW\_size )}{{MAD}_{avg} ( SW\_size )} = \frac{{a}_{1 , SW}}{{QP}_{max}^{2}} + \frac{{a}_{2 , SW}}{{QP}_{max}}$$

Using QPₘᵢₙ and QPₘₐₓ, the initial value for the frame's QP is clipped at step 520 by the following equations and then the frame encoding starts:
QPᵢₙᵢₜᵢₐₗ(i)=MAX(QPₘᵢₙ,QPᵢₙᵢₜᵢₐₗ(i))
QPᵢₙᵢₜᵢₐₗ(i)=MIN(QPₘₐₓ,QPᵢₙᵢₜᵢₐₗ(i))

Because the RD characteristics of IDR frames are significantly different than those of P frames, another method is used to calculate IDR frame's initial QP:

The complexity of the frame (i) is estimated at step 525 using the following:
C(i)=(Var^{Avg}+TexH^{Avg}+TexV^{Avg}) Eq. (7)

Var^{avg} is the average variance of the frame's luminance component. Var^{avg} is calculated by averaging all of the macroblock's variances. TexH^{Avg} and TexV^{Avg} are calculated by averaging the horizontal and vertical texture functions for the macroblock that is given in the following equations:

$${TexH}_{MB} = {\sum }_{i = 1}^{15} {\sum }_{j = 0}^{15} \vert P ( i , j ) - P ( i - 1 , j ) \vert$$

$${TexV}_{MB} = {\sum }_{i = 0}^{15} {\sum }_{j = 1}^{15} \vert P ( i , j ) - P ( i , j - 1 ) \vert$$

In these equations, P is the array holding macroblock's luminance data. At step 530, it is determined if the frame is the first picture of the video. If the frame is the first picture of the video, it is first determined whether C(i) is lower than a predetermined threshold at step 575. If C(i) is lower than the threshold, then the initial QP is set to the maximum value of QP at step 580. If C(i) is not lower than the threshold, the frame is checked to determine whether an initial QP is provided at step 585. If an initial QP is provided, then the input QP is set as the initial QP at step 590. If no initial QP is provided, then the first frame's QP is calculated at step 595 as:

$${QP}_{initial} ( 0 ) = \frac{{K}_{1} \cdot C ( 0 )}{\frac{{R}_{video}}{f} \cdot IP\_Ratio - {K}_{2}} \qquad Eq . ( 8 )$$

K₁,K₂ and IP_Ratio are the complexity parameters in this equation. For IDR pictures occurring after the first picture, it is first checked at step 535 whether the IDR is a result of a scene-cut or periodic insertion. If there is a scene-cut occurring, the short window RD model is reset to the initial stage at step 540. Also, the complexity of the first frame of the scene is compared with the average complexity of the previous frames at step 545. If the difference is larger than a predetermined threshold, the long window RD model is reset as well at step 550. The initial QP of the frame is calculated at step 555 using Equation (8) discussed above, and the initial QP is clipped at step 560. If the IDR picture is not due to a scene change, then the previous P frame's QP is decreased by certain amount X and used for the current IDR picture's QP at step 565. This is followed by the initial QP being clipped at step 570.

The encoding for frame (i) is started with QPᵢₙᵢₜᵢₐₗ(i). After encoding each one or more macroblocks, the number bits that will be generated for the frame are estimated. This estimation is accomplished by comparing the bits generated at the same spatially located group-of-MBs for the previous frame, using the following equation:

$${R}_{estimate} ( i ) = {R}_{group} ( i , j ) + {R}_{group} ( i , j ) \cdot \frac{{R}_{frame} ( i - 1 ) - {R}_{group} ( i - 1 , j )}{{R}_{group} ( i - 1 , j )}$$

In this equation, Rₑₛₜᵢₘₐₜₑ(i) is the estimated number of bits for the frame, R_{goup}(i,j) is the number of bits used at frame (i) after encoding j number of group-of-MBs, and R_{frame}(i-1) is the number of bits used for frame i-1.

When the previous frame's information cannot be used (e.g. for P frames following an IDR frame), the following equation is implemented:

$${R}_{estimate} ( i ) = {R}_{group} ( i , j ) \cdot \frac{N}{j}$$

N is the number of group-of-MBs contained within a frame. For example, if a group-of-MBs contains only one MB, then N equals the number of macroblocks within the frame. The estimated number of bits (Rₑₛₜᵢₘₐₜₑ(i)) is compared with the bit-envelope of the frame (Rᵤₚₚₑᵣ(i) and R_{lower}(i)). If Rₑₛₜᵢₘₐₜₑ(i) is larger than Rᵤₚₚₑᵣ(i), the QP for the next group of MBs is increased by a certain amount. Similarly, if Rₑₛₜᵢₘₐₜₑ₍ᵢ₎ is smaller than R_{lower}(i), then the QP for the next group of MBs is decreased.

A frame may be re-encoded after its encoding is finished. This re-encoding step is optional and is not appropriate for certain applications, such as for real-time encoding of video at a handheld terminal. For these types of applications, this step is not used. However, for certain applications, such as local recording at a personal computer, re-encoding some frames can improve the performance significantly. The frame is re-encoded with a different QP if any one of the following conditions hold:

1. The number of QP changes while coding the frame is larger than a certain threshold. The frame is re-encoded by the average of the different QPs used for the frame.

2. The buffer fullness after coding the first frame is larger than a predetermined threshold. The frame's QP is increased and re-encoded until the buffer fullness is below the threshold level.

3. The difference between the number of bits used for the frame and the frame's bit-envelope is larger than a predetermined threshold. The frame is re-encoded by the average of the different QPs used for the frame.

After the optional re-encoding step, the RD models are updated according to the average QP, MAD and number of bits used for texture. A least squares estimation method is used for the update.

The present invention includes a variety of different embodiments, and a number of alternatives can be used in the implementation of the present invention. For example, RD models other than the model presented in Equation (1) can be used. The sizes of SW and LW RD models is chosen to be 15 and 100 frames, respectively, in one embodiment of the invention, but these can be altered. Likewise, although the Kₚ and K_{I} parameters for the PI regulator are chosen as 0.15 and 0.05, respectively in one embodiment, these values may vary. The complexity of the frame could be calculated in a different manner than the method presented in Equation (7). The boundaries of the zones defined in Equations (5) and (6) can also be altered. The bit_adjust_window, W, in Eq. 2 is chosen to be 30 in one embodiment of the invention, but this value can also be different. The Rᵤₚₚₑᵣ(i) and R_{lower}(i) may be larger or smaller than the values presented previously, and although QP_{LW} is updated once every 5 frames in one embodiment of the invention, this period can also be varied.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of providing rate control for a video encoder, comprising:
upon the initiation of video encoding, initializing at least one rate control-related parameter; and
performing an encoding process for each frame including,
prior to encoding the frame, calculating an initial quantization parameter for the frame,
upon initiating encoding of the frame, encoding a group of macroblocks within the frame,
if the end of the frame has not been reached, adjusting the initial quantization parameter for the next group of macroblocks,
encoding each next group of macroblocks until the end of the frame has been reached, and
if necessary, calculating an updated initial quantization parameter for the frame and repeating the encoding process for the frame.

2. The method of claim 1, wherein the at least one rate control-related parameter is selected from the group consisting of bit rate and buffer size.

3. The method of claim 1, further comprising, before calculating an initial quantization parameter for the frame, determining whether the frame is a P frame or an ideal data representation frame.

4. The method of claim 3, wherein if the frame is a P frame, the initial quantization parameter is calculated by:
calculating values for short window and long window quantization parameters;
calculating the initial quantization parameter based upon the short window and long window quantization parameters;
calculating a bit envelope for the frame; and
clipping the value for the frame's initial quantization parameter.

5. The method of claim 3, wherein if the frame is an ideal data representation frame, the initial quantization parameter is calculated by:
estimating the complexity of the frame;
if the frame is the first frame of the video, determining whether the estimated complexity is less than a predetermined threshold;
if the estimated complexity is less than the predetermined threshold, setting the initial quantization parameter at a predetermined maximum value;
if the estimated complexity is not less than the predetermined threshold and the initial quantization parameter is provided, accepting the initial quantization parameter as an input quantization parameter;
if the estimated complexity is not less than the predetermined threshold and the initial quantization parameter is not provided, calculating the initial quantization parameter; and
calculating a bit envelope for the frame

6. The method of claim 5, wherein the initial quantization parameter is further determined by, if the frame is not the first frame of the video and if the frame is not the result of a scene cut or periodic insertion,
decreasing the previous P frame's quantization parameter by a predetermined amount;
using the decreased P frame's quantization parameter as the frame's initial quantization parameter; and
clipping the frame's initial quantization parameter.

7. The method of claim 5, wherein the initial quantization parameter is further determined by, if the frame is not the first frame of the video and if the frame is the result of a scene cut or periodic insertion,
resetting a short window rate distortion model to an initial stage;
comparing the complexity of the first frame of the video to the average complexity of previous frames;
if the complexity of the first frame of the video is not greater than the average complexity of the previous frames:
calculating the initial quantization parameter, and
clipping the initial quantization parameter; and
if the complexity of the first frame of the video is greater than the average complexity of the previous frames:
resetting a long window rate distortion model to an initial stage,
calculating the initial quantization parameter, and
clipping the initial quantization parameter.

8. A computer program product for providing rate control for a video encoder, comprising:
computer code for, upon the initiation of video encoding, initializing at least one rate control-related parameter; and
computer code for performing an encoding process for each frame including,
prior to encoding the frame, calculating an initial quantization parameter for the frame,
upon initiating encoding of the frame, encoding a group of macroblocks within the frame,
if the end of the frame has not been reached, adjusting the initial quantization parameter for the next group of macroblocks,
encoding each next group of macroblocks until the end of the frame has been reached, and
if necessary, calculating an updated initial quantization parameter for the frame and repeating the encoding process for the frame.

9. The computer program product of claim 8, wherein the at least one rate control-related parameter is selected from the group consisting of bit rate and buffer size.

10. The computer program product of claim 8, further comprising computer code for, before calculating an initial quantization parameter for the frame, determining whether the frame is a P frame or an ideal data representation frame.

11. The computer program product of claim 10, further comprising computer code for, if the frame is a P frame, calculating the initial quantization parameter by:
calculating values for short window and long window quantization parameters;
calculating the initial quantization parameter based upon the short window and long window quantization parameters;
calculating a bit envelope for the frame; and
clipping the value for the frame's initial quantization parameter.

12. The computer program product of claim 10, further comprising computer code for, if the frame is an ideal data representation frame, calculating the initial quantization parameter by:
estimating the complexity of the frame;
if the frame is the first frame of the video, determining whether the estimated complexity is less than a predetermined threshold;
if the estimated complexity is less than the predetermined threshold, setting the initial quantization parameter at a predetermined maximum value;
if the estimated complexity is not less than the predetermined threshold and the initial quantization parameter is provided, accepting the initial quantization parameter as an input quantization parameter; and
if the estimated complexity is not less than the predetermined threshold and the initial quantization parameter is not provided, calculating the initial quantization parameter.

13. The computer program product of claim 12, wherein the initial quantization parameter is further determined by, if the frame is not the first frame of the video and if the frame is not the result of a scene cut or periodic insertion,
decreasing the previous P frame's quantization parameter by a predetermined amount;
using the decreased P frame's quantization parameter as the frame's initial quantization parameter; and
clipping the frame's initial quantization parameter.

14. The computer program product of claim 12, wherein the initial quantization parameter is further determined by, if the frame is not the first frame of the video and if the frame is the result of a scene cut or periodic insertion,
resetting a short window rate distortion model to an initial stage;
comparing the complexity of the first frame of the video to the average complexity of previous frames;
if the complexity of the first frame of the video is not greater than the average complexity of the previous frames:
calculating the initial quantization parameter, and
clipping the initial quantization parameter; and
if the complexity of the first frame of the video is greater than the average complexity of the previous frames:
resetting a long window rate distortion model to an initial stage,
calculating the initial quantization parameter, and
clipping the initial quantization parameter.

15. An electronic device, comprising:
a processor; and
a memory unit operatively connected to the processor and including a computer program product for providing rate control for a video encoder, comprising:
computer code for, upon the initiation of video encoding, initializing at least one rate control-related parameter; and
computer code for performing an encoding process for each frame including,
prior to encoding the frame, calculating an initial quantization parameter for the frame,
upon initiating encoding of the frame, encoding a group of macroblocks within the frame,
if the end of the frame has not been reached, adjusting the initial quantization parameter for the next group of macroblocks,
encoding each next group of macroblocks until the end of the frame has been reached, and
if necessary, calculating an updated initial quantization parameter for the frame and repeating the encoding process for the frame.

16. The electronic device of claim 15, further comprising computer code for, before calculating an initial quantization parameter for the frame, determining whether the frame is a P frame or an ideal data representation frame.

17. The electronic device of claim 16, further comprising computer code for, if the frame is a P frame, calculating the initial quantization parameter by:
calculating values for short window and long window quantization parameters;
calculating the initial quantization parameter based upon the short window and long window quantization parameters;
calculating a bit envelope for the frame; and
clipping the value for the frame's initial quantization parameter.

18. The electronic device of claim 16, further comprising computer code for, if the frame is an ideal data representation frame, calculating the initial quantization parameter by:
estimating the complexity of the frame;
if the frame is the first frame of the video, determining whether the estimated complexity is less than a predetermined threshold;
if the estimated complexity is less than the predetermined threshold, setting the initial quantization parameter at a predetermined maximum value;
if the estimated complexity is not less than the predetermined threshold and the initial quantization parameter is provided, accepting the initial quantization parameter as an input quantization parameter; and
if the estimated complexity is not less than the predetermined threshold and the initial quantization parameter is not provided, calculating the initial quantization parameter.

19. The electronic device of claim 18, wherein the initial quantization parameter is further determined by, if the frame is not the first frame of the video and if the frame is not the result of a scene cut or periodic insertion,
decreasing the previous P frame's quantization parameter by a predetermined amount;
using the decreased P frame's quantization parameter as the frame's initial quantization parameter; and
clipping the frame's initial quantization parameter.

20. The electronic device of claim 18, wherein the initial quantization parameter is further determined by, if the frame is not the first frame of the video and if the frame is the result of a scene cut or periodic insertion,
resetting a short window rate distortion model to an initial stage;
comparing the complexity of the first frame of the video to the average complexity of previous frames;
if the complexity of the first frame of the video is not greater than the average complexity of the previous frames:
calculating the initial quantization parameter, and
clipping the initial quantization parameter; and
if the complexity of the first frame of the video is greater than the average complexity of the previous frames:
resetting a long window rate distortion model to an initial stage,
calculating the initial quantization parameter, and
clipping the initial quantization parameter.
